(19) United States
(12) Patent Application Publication
(10) Pub. No.: US 2003/0078083 A1
(43) Pub. Date: Apr. 24, 2003

(54) Radio communication device having voice messaging

(76) Inventor: Jack L. Meador, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/003,658

(22) Filed: Oct. 18, 2001

(51) Int. Cl. H04B 1/38

(52) U.S. Cl. 455/575; 455/412; 455/413

(57) ABSTRACT

The present invention is a two-way radio. The radio includes a radio signal transmitter. A radio signal receiver system is provided including a receiver control system having a memory, configured to convert radio signals to demodulated audio signals and store the audio signals.

### FIELD OF THE INVENTION

The present invention generally relates to radio communication devices, and in particular, to a radio device having voice messaging.

### BACKGROUND OF THE INVENTION

Two-way radios are used as personal communication devices which allow people to communicate while “on the go” such as hiking, camping, at sporting events or other outdoor events. Past known two-way radios (e.g., walkie-talkies) had a relatively short communication range (e.g., ¼ mile) and were limited to communication across a signal frequency. More recent two-way radios have a maximum communication range from two to five miles and provide for communication over a number of different frequencies. For example, a typical two-way radio operates over up to fourteen channels which range between 462.5625 and 467.7125 megahertz. Each channel covers a predefined frequency range. For example, see Talkabout® two-way radios commercially available from Motorola.

In order for individuals to communicate using two-way radios, each two-way radio must be powered on and set to the same channel or frequency. This establishes a simplex communication channel between each two-way radio. Each two-way radio has a receive/listen mode and a send mode. Once the two-way radio device is powered on, it typically defaults to a receive mode. In the receive mode, the two-way radio receives radio signals within the communication range of the device at the set channel or frequency. Typically a button is pushed to switch the two-way radio from a receive mode to a talk mode. In the talk mode, the user transmits voice or audio signals within the two-way radio communication range at the set frequency, which are receivable by another two-way radio set to the same frequency within its communication range. Only one two-way radio on a given channel may operate in talk mode at any given time.

Often times two-way radios are used for communicating between individuals during outdoor activities. Problems occur when an individual receiving a message is unable to respond or listen to the message due to the outdoor activity. When this situation occurs, the individual will not only miss the message, but also not be aware that another individual tried to contact him. For example, two-way radio communication devices may be used between individuals or a group of individuals while downhill skiing. A first skier may be trying to communicate with a second skier while the second skier is in the process of skiing down a hill. The first skier wants to tell the second skier to meet at the lodge in 15 minutes. The second skier is unable to receive or respond to the message, since the second skier is in the process of skiing down the hill.

It is desirable to have a simplex radio communication device which is able to receive and store audio signals or messages which can be played back or listened to at a later time.

### SUMMARY OF THE INVENTION

The present invention is a two-way radio. The radio includes a radio signal transmitter. A radio signal receiver system is provided including a receiver control system having a memory, configured to convert radio signals to audio signals and store the audio signals.

### BRIEF DESCRIPTION OF THE DRAWINGS

FIG. 1 is a diagram illustrating one exemplary embodiment of a radio communication device having voice messaging according to the present invention.

FIG. 2 is a block diagram illustrating one exemplary embodiment of a radio communication device according to the present invention.

FIG. 3 is a block diagram illustrating another exemplary embodiment of a radio communication device according to the present invention.

FIG. 4 is a block diagram illustrating another exemplary embodiment of a radio communication device according to the present invention.

FIG. 5 is a flow chart illustrating one exemplary embodiment of a method of operating a two-way radio device having voice messaging according to the present invention.

FIG. 6 is a diagram illustrating another exemplary embodiment of a method of operating a radio communication device having voice messaging according to the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

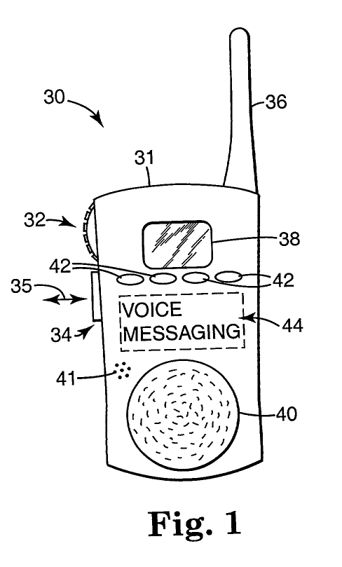

FIG. 1 is a diagram illustrating one exemplary embodiment of a radio communication device 30 according to the present invention. In one aspect, the radio communication device illustrated is a simplex, two-way radio communication device. The two-way radio communication device 30 is capable of storing audio signals or voice messages for playback at a later time. In one aspect, the two-way radio communication device 30 includes a transmitter system and a receiver system. The receiver system includes a receiver control system and a memory storage device. The receiver control system operates to receive audio signals and store the audio signals in the memory storage device.

In one exemplary embodiment, two-way radio communication device 30 includes housing 31, volume adjustment dial 32, push to talk button 34, antenna 36, display 38, audio speaker 40, audio microphone 41, control buttons 42 and audio signal or voice message storage system 44 (indicated by dashed lines). Volume adjustment dial 32 operates to adjust the volume of audio signals transmitted via audio speaker 40. Push-to-talk button 34 operates to switch two-way radio 30 between a receive or listen mode and a transmit or talk mode (indicated by arrow 35). In one aspect, the default mode is a receive mode. By pushing button 34, the two-way radio is switched from a receive mode to a transmit mode. In the receive mode, audio signals are received via antenna 36. In the transmit mode, audio signals are transmitted via antenna 36.

Display 38 operates to display control parameters for two-way radio 30. In one aspect, display 38 is operable to display the frequency channel, transmit code, and other indicators, such as battery level. Control buttons 42 are operable to change the frequency channel, scan a range of frequency channels, and set other control parameters such as the identification code. With the present invention, control buttons 42 are used to switch the two-way radio between a direct or bypass receive mode and a standby receive mode where voice messages are stored in memory. The use of identification codes with the present invention is described in detail further in this application.

In the receive mode, voice message storage system 44 allows for audio signals or voice messages to be stored locally in two-way radio 30. Through manipulation of control buttons 42, the stored voice message or other signal can be retrieved and listened to at a later time. The unique system for storing voice messages within two-way radio 30 according to the present invention is described in detail in this application.

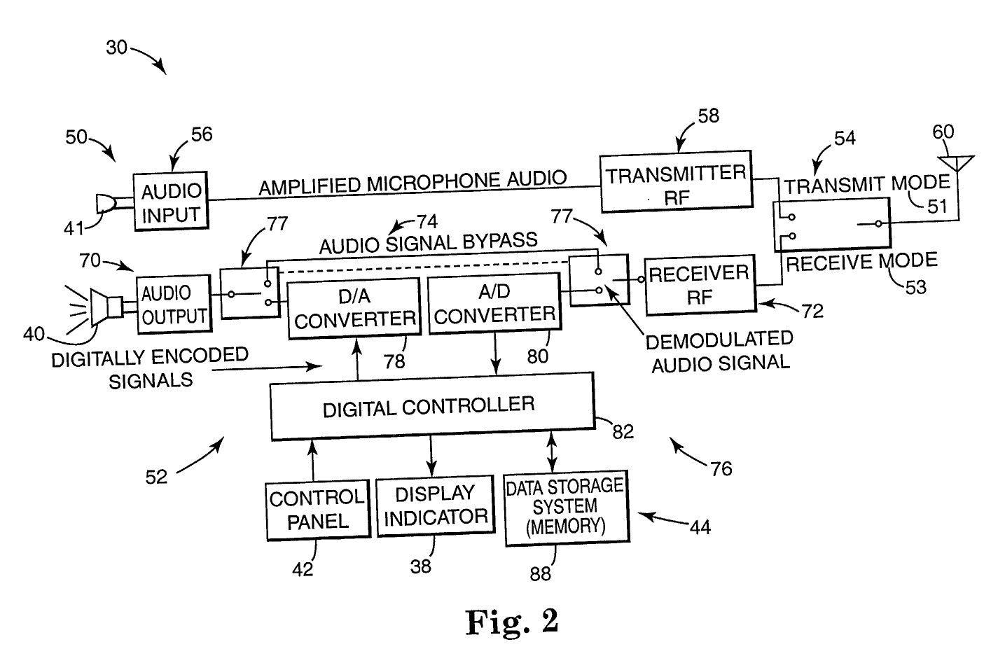

FIG. 2 is a block diagram illustrating one exemplary embodiment of two-way radio communication device 30 according to the present invention. Two-way radio device 30 includes a transmitter system 50 and a receiver system 52. The transmitter system 50 allows two-way radio device 30 to operate in a “transmit mode” and the receiver system 52 allows the two-way radio device 30 to operate in a “receive mode.” Switch 54, coupled to push-to-talk button 34, is operable for changing (i.e., switching) two-way radio 30 between the transmit mode 51 and the receive mode 53.

Transmitter system 50 includes audio input system 56 having audio microphone 41, and radio frequency (RF) transmitter 58. In a transmit mode 51, audio signals (e.g., voice messages) are input via audio input system 56 at microphone 41, amplified, and transmitted from RF transmitter 58 via antenna 60. In receive mode 53, receiver system 52 is operational in a receiver “bypass” mode and a standby mode. In the receiver bypass mode, radio signals are received via antenna 60 and demodulated audio is output via audio output system 70. When receiver system 52 is in a standby mode, radio signals are received via antenna 60 and demodulated audio is stored in a memory storage device, where it may be retrieved and listened to via audio speaker 40 at a later time.

Receiver system 52 includes audio output system 70, radio frequency receiver 72, bypass system 74, standby system 76, and a switch mechanism 77 for switching the receiver system 52 between the bypass 74 (i.e., a bypass mode) and the standby system 76 (i.e., standby, audio signal or message mode). In the bypass mode, radio signals are received by RF receiver 72 via antenna 60. The RF receiver 72 provides a demodulated audio signal via the bypass system 74 to audio output system 70, such that the audio signals are output via speaker 40. As such, the bypass system 74 operates to “bypass” the standby system 76.

Standby system 76 operates to store audio signals received via RF receiver 72, such that they may be retrieved at a later time. In one embodiment, standby system 76 includes digital to analog (D/A) converter 78, analog to digital (A/D) converter 80, digital controller 82, control panel 42, display indicator 38, and data storage system 88. A demodulated audio signal is received from radio frequency receiver 72 by A/D converter 80, which converts the demodulated audio signal to a digital signal. The digital signal is provided to digital controller 82. Digital controller 82 operates to store the audio signal in data storage system 88. Control panel 42, including control buttons 42 indicated in FIG. 1, provide control inputs to digital controller 82. Digital controller 82 provides a display output to display indicator 38, such as the display outputs previously described herein. If a user wants to retrieve the stored audio signals or message, control buttons 42 are operated, providing a signal to digital controller 42. In response, digital controller 42 operates to retrieve the audio signals stored in data storage system 88 and output the audio signals to D/A converter 78. D/A converter 78 converts the audio signals from digitally encoded signals to analog audio signals which are provided to audio output system 70, and can be heard via speaker 40.

Data storage system 88 is preferably a non-volatile data storage system. In one aspect, data storage system 88 includes a non-volatile memory device. Suitable non-volatile memory devices include flash memory, MRAM, or other persistent storage device such as a micro disk drive.

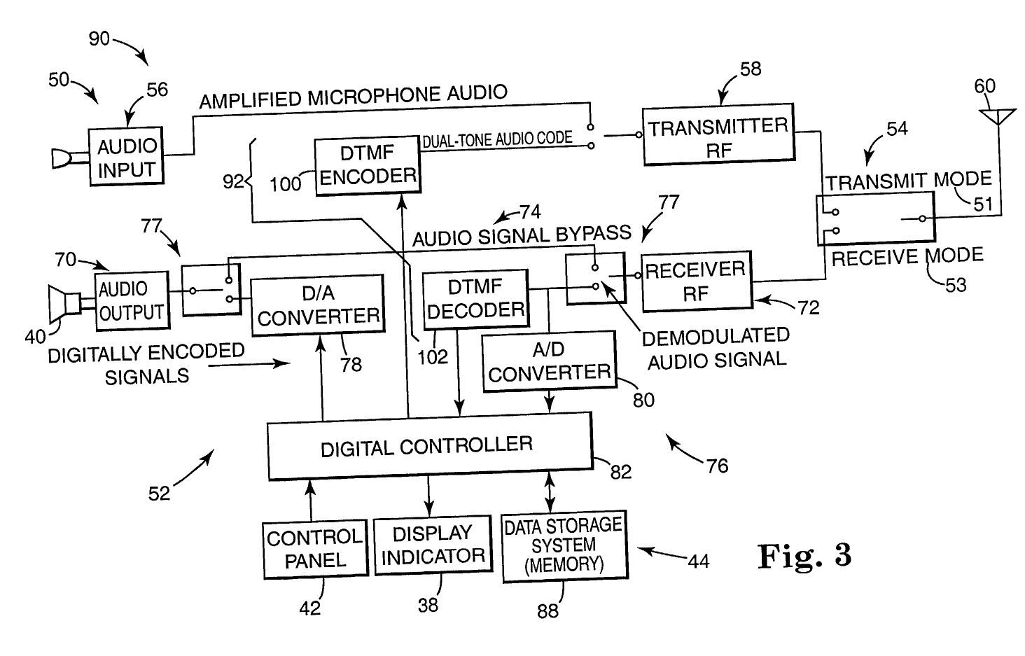

FIG. 3 is a block diagram illustrating another exemplary embodiment of a two-way radio device having voice messaging 90 according to the present invention. Two-way radio communication device 90 is similar to two-way radio communication device 30 previously described herein, and further includes a system 92 for associating a unique code with audio signals that are desired to be transmitted and received via the two-way radio communication device 90. In particular, a typical two-way radio device is operated at a specific frequency. As such, the two-way radio device receives any audio signal or voice message within its communication range at that frequency, such that it would be broadcast or the voice message stored within device 90. Since it is only desirable to receive and store messages from certain other users, such as members or your “group”, the present invention provides for associating a unique code with any message transmitted from the two-way radio device 90. Each user in the group would set their two-way radio communication device to the same code. Messages received by each two-way radio communication device operate to discriminate between messages received which are associated with the same unique code, or messages received which are not associated with a code or associated with a different code. As such, the two-way radio communication device according to the present invention operates to only store voice messages associated with a unique code at a defined frequency, as previously decided upon by one or more users.

In one exemplary embodiment shown, the code system 92 includes an encoder 100 coupled to digital controller 82 and a decoder 102 coupled to digital controller 82. In one embodiment, encoder 100 is a dual tone multi-frequency (DTMF) encoder which assigns a predefined frequency or tone which is transmitted with each set of audio signals transmitted via transmitter system 50. In a similar matter, as audio signals are received by receiver system 52, decoder 102 operates to identify any codes associated with each set of audio signals. If any codes match the predefined code, in the standby mode the audio signals are stored in data storage system 88, and in a bypass mode the audio signals are output via audio output system 70. If a detected or identified code does not match a code predefined by a user, the digital controller 82 identifies the audio signals as undesirable, and as such does not store the audio signals in the data storage system 88. The digital controller 82 may also operate to prohibit the undesired audio signals being transmitted to audio output system 70, when two-way radio communication device 90 is in a bypass mode.

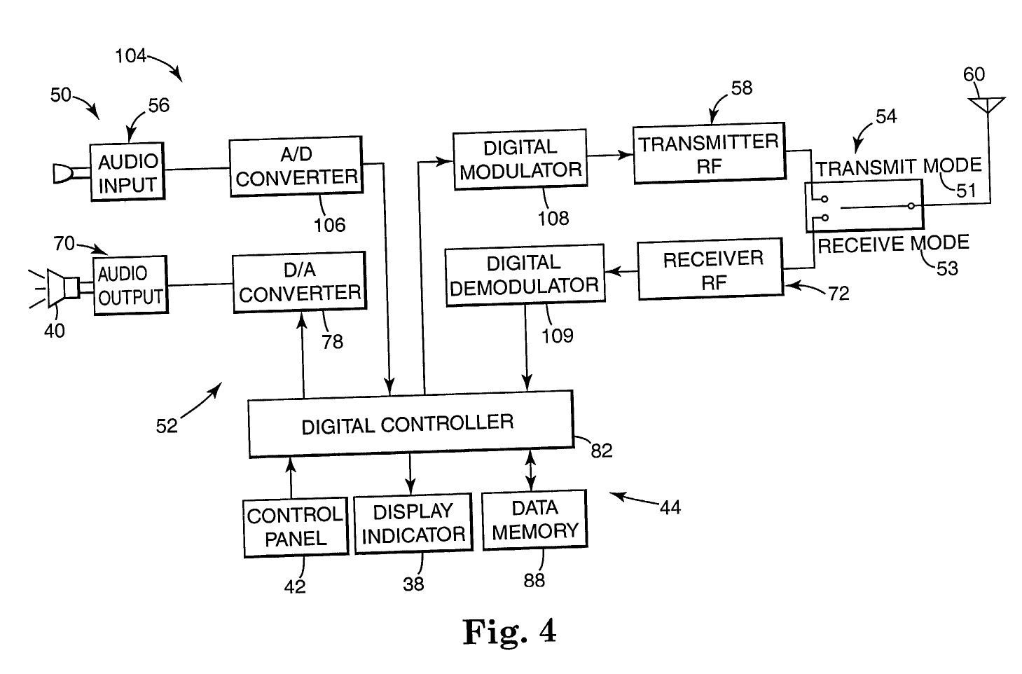

FIG. 4 is a block diagram illustrating another exemplary embodiment of a two-way radio communication device 104 according to the present invention. The two-way radio communication device 104 is similar to the two-way radio communication devices 30, 90 previously described herein. Two-way radio communication device 104 includes an A/D converter 106, digital modulator 108 and digital demodulator 109. In a transmit mode, audio input signals are received via audio input system 56 and converted to a digital signal via A/D converter 106. The digital signal is input to digital controller 82. Digital controller 82 operates to control and condition the digital signal (e.g., amplify the digital signal). A digital signal is subsequently output to digital modulator 108, which provides a modulated output signal to RF transmitter 58. The radio signals are then output from RF transmitter 58 via antenna 60. In a receive mode, audio signals are received by RF receiver 72 via antenna system 60. A demodulated audio signal is provided to digital demodulator 109, and subsequently output to digital controller 82. In a bypass mode, digital controller 82 provides an output to D/A converter 78, for converting the digitally encoded signal to an analogue output signal for outputting via audio output system 70. In a standby mode, the digital controller 82 operates to store the audio signals and data storage system 88. Upon receiving a signal from control panel 42, digital controller 82 operates to retrieve the audio signals from memory and output them via D/A converter 78 and audio output system 70.

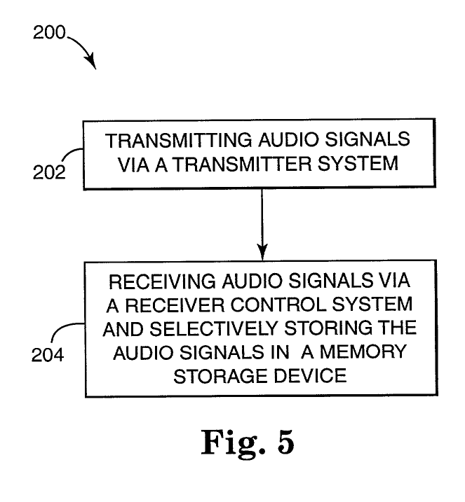

FIG. 5 is a diagram illustrating one exemplary embodiment of a method of operating a two-way radio device having voice messaging according to the present invention, indicated at 200. At 202, the method includes transmitting audio signals via a transmitter system. At 204, audio signals are received via a receiver control system and selectively stored in a memory storage device.

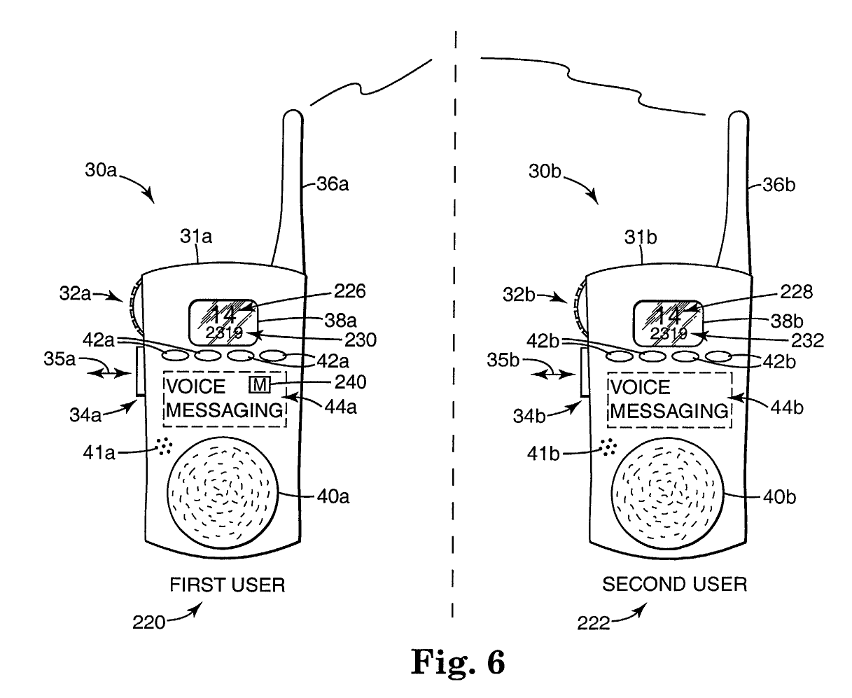

FIG. 6 is a diagram illustrating another exemplary embodiment of a method of operating a two-way radio communication device having voice messaging according to the present invention. In this embodiment, the first user 220 has a two-way radio communication device as previously described herein, indicated at 30(a). Similarly, second user 222 has a two-way radio communication device 30(b). The first user 220 and second user 222 adjust two-way communication devices 30(a), 30(b) to the same frequency range, channel 14 indicated at 226, 228. As such, both communication devices 30(a), 30(b) receive and transmit radio signals within the frequency range associated with channel 14. Further, since first user 220 and second user 222 only want to receive radio signals from each other a code 230, 232 has been selected, represented by 2319. As such, both first user 220 and second user 222 will only receive audio signals or messages having code 2319 associated with them. For example, first user 220 and second user 222 may be skiing. Prior to skiing down a hill, first user 220 puts his two-way radio communication device 30(a) in a standby mode. As such, voice messages received by two-way radio communication device 30(a) will be stored in memory, indicated at 44(a).

As first user 220 is skiing down a hill, second user 222 attempts to reach first user 220 to give first user 220 a message. Second user 222 tells first user 220 to meet second user 222 at the lodge in 10 minutes. Since two-way communication device 30(a) is in a standby mode, the message received from two-way communication device 36(b) is stored in memory, indicated at 240. Further, first user 220 will only receive messages from second user 222, and in particular, messages having the code 2319, indicated at 230. Once first user 220 reaches the bottom of the hill, first user 220 checks messages on the two-way communication device 30(a) and receives the message 240 indicating that first user 220 is to meet second user 222 at the lodge in 10 minutes.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A two-way radio comprising:
a radio signal transmitter; and
a radio signal receiver including a receiver control system having a memory configured to convert radio signals to demodulated audio signals and store the demodulated audio signals in memory.

2. The radio claim 1, further comprising:
a switch operable for switching between the transmitter and the receiver.

3. The radio of claim 2, further comprising:
an antenna coupled to the switch, wherein the switch is operable to switch the antenna between the transmitter and the receiver.

4. The radio of claim 1, further comprising an audio output for outputting audio signals.

5. The radio of claim 1, wherein the receiver control system further includes a controller configured for receiving the audio signals, storing the audio signals in memory, and retrieving the audio signals from memory and outputting the audio signals to the audio output.

6. The radio of claim 4, wherein the receiver control system includes an analog to digital converter for receiving the audio signals and converting them to digital audio signals; a controller for storing the digital audio signals in memory and retrieving the digital audio signals from memory; and a digital to analog converter for receiving the digital audio signals from memory via the controller and converting the digital audio signals to analog audio output signals which are output to the audio output.

7. The radio of claim 6, further comprising a control panel coupled to the receiver control system.

8. The radio of claim 6, further comprising a display indicator coupled to the receiver control system for indication of the presence of audio signals stored in memory.

9. The radio of claim 1, further comprising:
an audio output system for outputting audio signals;
a receiver for receiving radio signals and converting the radio signals to demodulated audio signals;
a bypass system configured for selectively coupling the receiver to the audio output system, and bypassing the receiver control system.

10. A two-way radio comprising:
an antenna;
a transmitter system for transmitting modulated radio signals via the antenna; and
a receiver system including an audio output, a receiver for receiving modulated radio signals via the antenna, a standby system including a memory wherein the standby system is configured for receiving audio signals from the receiver and storing the audio signals in the memory, and selectively outputting the stored audio signals to the audio output and a bypass system configured for bypassing the standby system for directly outputting audio signals from the receiver to the audio output.

11. The radio of claim 10, wherein the standby system further comprises an analog to digital converter, a controller, and a digital controller.

12. The radio of claim 10, further comprising:
a first switch for switching the antenna between the transmitter system and the receiver system;
a second switch for switching the receiver between the standby system and the bypass system.

13. A radio comprising:
an antenna; and
a receiver system including an audio output, a receiver for receiving radio signals via the antenna, a standby system including a memory storage device wherein the standby system is configured for receiving radio signals from the receiver, converting the radio signals to audio signals and storing the audio signals in the memory storage device, and selectively outputting the stored audio signals to the audio output and a bypass system configured for bypassing the standby system for directly outputting audio signals from the receiver to the audio output.

14. The radio of claim 13, further comprising a transmitter system for transmitting modulated radio signals via the antenna.

15. The radio of claim 14, further comprising:
an encoder for providing a unique identification code associated with the modulated radio signals transmitted via the transmitter system.

16. The radio of claim 14, further comprising:
decoder for decoding a unique identification code associated with the radio signals received via the receiver.

17. The radio of claim 16, further wherein the decoder is coupled to the controller, and wherein the controller receives the unique code from the decoder, compares it to a stored code, and only if the unique code matches the stored code the controller operates to store the associated audio message in the memory storage device.

18. A two-radio comprising:
an antenna;
a controller;
a memory storage device;
a transmitter system for transmitting modulated radio signals via the antenna; and
a receiver system for receiving modulated radio signals via the antenna, converting the modulated radio signals to demodulated audio signals and storing the demodulated audio signals in the memory storage device via the controller, and selectively outputting the demodulated audio signals from the memory storage device via the controller.

19. The radio of claim 18, further comprising a switch for switching the antenna between the transmitter system and the receiver system.

20. The radio of claim 18, wherein the transmitter system includes a radio frequency transmitter, a digital modulator, an analog to digital converter, and an audio input system.

21. The radio of claim 18, wherein the receiver system includes a radio frequency receiver, a digital modulator, a digital to analog converter, and an audio output system.

22. The radio of claim 18, further comprising a control panel in communication with the controller.

23. The radio of claim 18, further comprising a display indicator in communication with the controller for providing a display output representative of indicating that audio signals are stored in the memory storage device.

24. A method of operating a two-way radio comprising:
transmitting modulated radio signals via a transmitter system; and
receiving demodulated audio signals via a receiver system including a receiver control system and a memory storage device, including receiving the audio signals via the receiver control system and storing the audio signals in the memory storage device.

25. The method of claim 24, further comprising providing an audio signal output system; and selectively outputting the audio signals from the memory storage device via the audio signal output system.

26. The method of claim 24, further comprising storing a first code; receiving a second code associated with the audio signals; determining if the first code matches the second code; and only if the first code matches the second code, then storing the audio signals in the memory storage device.

27. The method of claim 24, further comprising transmitting a unique code associated with the modulated radio signals transmitted via the antenna.

28. The method of claim 24 further comprising:
switching between the transmitter system and the receiver system.
